(19) United States
(12) Patent Application Publication
(10) Pub. No.: US 2015/0295225 A1
(43) Pub. Date: Oct. 15, 2015

(54) COPPER-MODIFIED LITHIUM TITANATE AND USE THEREOF IN A LITHIUM-ION BATTERY

(71) Applicant: E I DU PONT DE NEMOURS AND COMPANY, Wilmington, DE (US)

(72) Inventors: JEFFREY A. THOMPSON, EDWARDSVILLE, IL (US); H. DAVID ROSENFELD, DRUMORE, PA (US)

(21) Appl. No.: 14/645,442

(22) Filed: Mar. 12, 2015

Related U.S. Application Data
(60) Provisional application No. 61/978,215, filed on Apr. 11, 2014.

(51) Int. Cl. H01M 4/131; H01M 4/485

(52) U.S. Cl. CPC H01M 4/131; H01M 4/485; H01M 2004/027

(57) ABSTRACT

A modified lithium titanate compound represented by formula I:

Li₄₋₂ₓTi₅₋ₓCu₃ₓO₁₂ (I)

wherein x is a fraction in the range of 0.025 to 0.370 and wherein the compound is a single phase cubic spinel with space group Fm-3m. Also, the use of Compound (I) as an electroactive material in an electrode of an electrochemical cell, particularly a lithium-ion battery.

### FIELD OF THE INVENTION

A modified lithium titanate compound, an electrode comprising the modified lithium titanate compound as the electroactive material, and a lithium-ion battery comprising an electrode comprised of the modified lithium titanate compound.

### BACKGROUND OF THE INVENTION

Lithium-ion batteries (LIB) are becoming increasingly important as energy storage devices, and improvements are being aggressively pursued.

Carbon is presently the most common anode material for lithium-ion batteries, but replacement of carbon with spinel lithium titanate (Li₄Ti₅O₁₂, also referred to as LTO) is being actively investigated because of its many favorable features such as of fast charge-discharge, good safety and long lifetime. However, the commercial success of LIB with LTO has been limited.

Various modifications of LTO have been made in an attempt to improve performance.

Da Wang et al. in “Li₂CuTi₃O₈—Li₄Ti₅O₁₂ double spinel anode material with improved rate performance for Li-ion batteries”, Electrochemistry Communications, 11, (2009) 50-53, disclose copper-doped LTO with nominal compositions of Li₄Ti₅CuₓO₁₂₊ₓ which were synthesized by solid-state reaction. X-ray diffraction analysis indicated the sintered materials were composed of intergrown spinel-type Li₄Ti₅O₁₂ and Li₂CuTi₃O₈. The X-ray pattern matched the standard pattern of Li₂CuTi₃O₈ with a space group P4₃32 which is distinguished from Li₄Ti₅O₁₂ by an extra peack around 24° two-theta. As an anode material, the copper doped LTO is reported to show largely improved rate performance compared to LTO.

T. Karhunen et al. in “Transition Metal-Doped Lithium Titanium Oxide Nanoparticles Made Using Flame Spray Pyrolysis”, ISRN Nanotechnology, volume 2011, Article ID 180821, disclose a single-step gas-phase technique for producing doped LTO. The copper dopant reacts with LTO to form a double spinel. The altered spinel phase is described as Li₂CuTi₃O₈ in solid solution with Li₄Ti₅O₁₂.

Jie Wang et al. in “Electrochemical characteristics of Li₄₋ₓCuₓTi₅O₁₂ used as anode material for lithium-ion batteries”, Ionics (2013)19:415-419 disclose copper-doped LTO having compositions Li₄₋ₓCuₓTi₅O₁₂. X-ray diffraction patterns of the synthesized samples are similar to the LTO spinel structure with the space group of Fd3m. The Cu²⁺ substitutes on Li¹⁺ sites and to maintain electrical neutrality, a Ti⁴⁺/Ti³⁺ mixed valence is formed. Cycling stability and rate capability can be significantly improved over undoped LTO.

There is still demand for a LTO-based battery with improved performance.

### SUMMARY OF THE INVENTION

In one aspect, the present invention pertains to a modified lithium titanate compound represented by formula I:

Li₄₋₂ₓTi₅₋ₓCu₃ₓO₁₂ (I)

wherein x is a fraction in the range of 0.025 to 0.370, and said compound (I) is a single phase cubic spinel with space group Fm-3m.

In another aspect, the present invention pertains to an electrode comprising the modified lithium titanate of formula (I) as an electroactive material.

In still another aspect, the present invention pertains to a lithium-ion battery comprising a positive and negative electrode wherein at least one of said electrodes comprises the modified lithium titanate of formula (I) as an electroactive material.

The modified lithium titanate prescribed herein provides improved performance as an electroactive material compared to unmodified lithium titanate.

### DETAILED DESCRIPTION OF THE INVENTION

“Lithium-ion battery” refers to a type of rechargeable battery in which lithium ions move from the anode to the cathode during discharge, and from the cathode to the anode during charge.

“Anode” refers to the electrode of an electrochemical cell, at which oxidation occurs. In a galvanic cell, such as a battery, the anode is the negatively charged electrode. In a secondary (i.e. rechargeable) battery, the anode is the electrode at which oxidation occurs during discharge and reduction occurs during charging.

“Cathode” refers to the electrode of an electrochemical cell, at which reduction occurs. In a galvanic cell, such as a battery, the cathode is the positively charged electrode. In a secondary battery, the cathode is the electrode at which reduction occurs during discharge and oxidation occurs during charging.

The compound of the present invention is a modified lithium titanate wherein copper is incorporated into the lithium titanate lattice (“Cu-LTO”) according to formula (I) as follows:

Li₄₋₂ₓTi₅₋ₓCu₃ₓO₁₂ (I)

In one embodiment, x is a fraction in the range of 0.025 to 0.370 which corresponds to a copper content of about 1 wt % to about 15 wt %. In another embodiment, x is a fraction in the range of 0.05 to 0.25. In still another embodiment, x is a fraction in the range of 0.099 to 0.185 which corresponds to a copper content of about 4.0 wt % to about 7.5 wt %. The Cu-LTO of formula (I) is a single phase cubic spinel with space group Fm-3m. All copper is present as Cu²⁺ and all Ti is present as Ti⁴⁺. For every three Cu²⁺ atoms substituted into the LTO structure, two substitute for Li⁺ on either the 8a or 16c sites and one substitutes for Ti⁴⁺ on the 16c site.

It will be apparent from the preceeding description that a given sample can be confirmed to be modified LTO according to formula (I) by standard elemental analysis and X-ray powder diffraction techniques. Elemental analysis methods include, for example, Inductively Coupled Plasma Atomic Emission Spectroscopy (ICP-AES). From the wt % copper, “x” in formula (I) can be calculated. From the powder pattern, the space group Fm-3m can be confirmed. From the refinement of the powder pattern, the substitution of the Cu for Li and Ti can be confirmed. If the oxidation states are in question, the presence of Cu²⁺ and Ti⁴⁺ and absence of Ti³⁺ can be confirmed by methods such as X-ray Absorption Near Edge Spectroscopy.

The preparation of LTO is well known and typically involves a calcination step to form the final product. Preparation of Cu-LTO can be accomplished by a similar method wherein a suitable copper precursor material is intimately mixed with the typical LTO starting materials prior to calcination. Suitable copper precursors species include water soluble copper compounds such as, for example, copper(II) formate and slightly water soluble copper compounds such as copper(II) hydroxide. The Cu-LTO as-made is typically a crystalline powder. The particle size of the Cu-LTO powder is not limited, but will typically have a volume median particle size in the range of 0.1 μm to 100 μm as measured by standard laser diffraction methods.

The Cu-LTO is advantageous as an electroactive material and can be formed into an electrode according to methods well-known in the art. Electrode ingredients typically include the electroactive material such as modified LTO according to this invention, a conductivity agent and a binder. Commonly, the electrode ingredients are mixed with solvent and formed into a paste which is cast onto a current collector. The solvent is then removed and the dried electrode is formed into the desired size and shape. The electrode may further comprise other ingredients known in the art.

The conductivity agent provides conductivity to the electrode and may be any one of various materials that do not cause any deleterious effects and that conduct electrons. Examples of the conductive agent include a carbonaceous material, such as natural graphite, artificial graphite, flaky graphite, carbon black, acetylene black, ketjen black, denka black, carbon fiber, carbon nanotube or graphene; a metallic material, such as copper powder or fiber, nickel powder or fiber, aluminum powder or fiber, or silver powder or fiber; a conductive polymer such as a polyphenylene derivative, and mixtures thereof.

The binder may allow active material particles to be attached to each other and the electroactive material to be attached to a current collector. Non-limiting examples of the binder include polyvinylalcohol, carboxymethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, and a mixture thereof. For example, the binder may be polyvinylidene fluoride (PVDF). The binder will typically be present in an amount of from 5 wt % to 10 wt % based on the weight of electroactive material.

The solvent used to make the electrode paste can be any one of various solvents commonly used for such purpose. Examples of the solvent include an acyclic carbonate such as dimethyl carbonate, ethyl methyl carbonate, diethyl carbonate or dipropyl carbonate, a cyclic carbonate such as ethylene carbonate, propylene carbonate or butylene carbonate, dimethoxyethane, diethoxyethane, a fatty acid ester derivative, gamma-butyrolactone, N-methylpyrrolidone (NMP), acetone, or water. The solvent may also be a combination of two or more of these.

The “current collector” refers to a structural part of an electrode assembly whose primary purpose is to conduct electricity between the actual working part of the electrode, and the terminals of an electrochemical cell. The current collector material may be any one of various materials commonly used in the art, for example, a copper foil or an aluminum foil, but is not limited thereto.

An electrode comprising modified LTO according to this invention is advantageous for use in an electrochemical cell. In some embodiments, the electrochemical cell is a lithium battery. In some embodiments, the lithium-ion battery comprises an anode, a cathode, a separator between the cathode and anode, an electrolyte, and a housing to enclose the battery.

As prescribed herein, the anode is an electrode comprising modified LTO according to this invention. The cathode is an electrode comprising suitable cathode-active material. The cathode-active material is any suitable electroactive material which can be advantageously paired with the modified LTO of this invention. The electrode comprising suitable cathode-active material can be formed in the same way as described herein before.

Suitable electroactive cathode materials include electroactive transition metal oxides comprising lithium, such as LiCoO₂, LiNiO₂, LiMn₂O₄, or LiV₃O₈; oxides of layered structure such as LiNiₓMn_{y}Co_{z}O₂ where x+y+z is about 1, LiCo_{0.2}Ni_{0.2}O₂, Li_{1+z}Ni_{1-x-y}CoₓAl_{y}O₂ where 0<x<0.3, 0<y<0.1, olivine structured LiFePO₄, LiMnPO₄, LiCoPO₄, and LiVPO₄F; spinel structured LiNi_{0.5}Mn_{1.5}O₄; mixed metal oxides of cobalt, manganese, and nickel such as those described in U.S. Pat. No. 6,964,828 and U.S. Pat. No. 7,078,128; nanocomposite cathode compositions such as those described in U.S. Pat. No. 6,680,145; lithium-rich layered-layered composite cathodes such as those described in U.S. Pat. No. 7,468,223; and cathodes such as those described in U.S. Pat. No. 7,718,319 and the references therein.

Another suitable electroactive material is a lithium-containing manganese composite oxide having a spinel structure as an electroactive cathode material. A lithium-containing manganese composite oxide suitable for use herein comprises oxides of the formula LiₓNi_{y}M_{z}Mn_{2-y-z}O_{4-d}, wherein x is 0.03 to 1.0; x changes in accordance with release and uptake of lithium ions and electrons during charge and discharge; y is 0.3 to 0.6; M comprises one or more of Cr, Fe, Co, Li, Al, Ga, Nb, Mo, Ti, Zr, Mg, Zn, V, and Cu; z is 0.01 to 0.18; and d is 0 to 0.3. In one embodiment in the above formula, y is 0.38 to 0.48, z is 0.03 to 0.12, and d is 0 to 0.1. In another embodiment in the above formula, M is one or more of Li, Cr, Fe, Co and Ga. Stabilized manganese cathodes may also comprise spinel-layered composites which contain a manganese-containing spinel component and a lithium rich layered structure, as described in U.S. Pat. No. 7,303,840.

Other suitable electroactive include layered oxides such as LiCoO₂ or LiNiₓMn_{y}Co_{z}O₂ where x+y+z is about 1, that can be charged to cathode potentials higher than the standard 4.1 to 4.25 V range in order to access higher capacity. Other examples are layered-layered high-capacity oxygen-release cathodes such as those described in U.S. Pat. No. 7,468,223 charged to upper charging voltages above 4.5 V.

The separator is porous and serves to prevent short circuiting between the anode and the cathode. The porous separator typically consists of a single-ply or multi-ply sheet of a microporous polymer such as polyethylene, polypropylene, polyamide or polyimide, or a combination thereof. The pore size of the porous separator is sufficiently large to permit transport of ions to provide ionically conductive contact between the anode and cathode, but small enough to prevent contact of the anode and cathode either directly or from particle penetration or dendrites which can from on the anode and cathode. Examples of porous separators suitable for use herein are disclosed in U.S. Patent Application Publication No. 2012/0149852.

“Electrolyte composition” as used herein refers to a chemical composition suitable for use as an electrolyte in an electrochemical cell. An electrolyte composition typically comprises at least one solvent and at least one electrolyte salt.

“Electrolyte salt” as used herein refers to an ionic salt that is at least partially soluble in the solvent of the electrolyte composition and that at least partially dissociates into ions in the solvent of the electrolyte composition to form a conductive electrolyte composition.

Typically, the electrolyte solvent comprises one or more alkyl carbonates including, for example, any one or a mixture of ethylene carbonate (EC), ethyl methyl carbonate (EMC) and dimethyl carbonate (DMC).

Suitable solvents for electrolyte compositions can also include fluorinated acyclic carboxylic acid esters, represented by the formula R¹—COO—R², where R¹ and R² independently represent an alkyl group, the sum of carbon atoms in R¹ and R² is 2 to 7, at least two hydrogen atoms in R¹ and/or R² are replaced by fluorine atoms and neither R¹ nor R² contains a FCH₂or FCH group. Examples of suitable fluorinated acyclic carboxylic acid esters include without limitation CH₃—COO—CH₂CF₂H (2,2-difluoroethyl acetate, CAS No. 1550-44-3), CH₃—COO—CH₂CF₃ (2,2,2-trifluoroethyl acetate, CAS No. 406-95-1), CH₃CH₂—COO—CH₂CF₂H (2,2-difluoroethyl propionate, CAS No. 1133129-90-4), CH₃—COO—CH₂CH₂CF₂H (3,3-difluoropropyl acetate), CH₃CH₂—COO—CH₂CH₂CF₂H (3,3-difluoropropyl propionate), and HCF₂—CH₂—CH₂—COO—CH₂CH₃ (ethyl 4,4-difluorobutanoate, CAS No. 1240725-43-2). In one embodiment, the fluorinated acyclic carboxylic acid ester is 2,2-difluoroethyl acetate (CH₃—COO—CH₂CF₂H).

Other suitable fluorinated acyclic carbonates are represented by the formula R³—OCOO—R⁴, where R³ and R⁴ independently represent an alkyl group, the sum of carbon atoms in R³ and R⁴ is 2 to 7, at least two hydrogen atoms in R³ and/or R⁴ are replaced by fluorine atoms and neither R³ nor R⁴ contains a FCH₂or FCH group. Examples of suitable fluorinated acyclic carbonates include without limitation CH₃—OC(O)O—CH₂CF₂H (methyl 2,2-difluoroethyl carbonate, CAS No. 916678-13-2), CH₃—OC(O)O—CH₂CF₃ (methyl 2,2,2-trifluoroethyl carbonate, CAS No. 156783-95-8),

CH₃—OC(O)O—CH₂CF₂CF₂H (methyl 2,2,3,3-tetrafluoropropyl carbonate, CAS No. 156783-98-1), HCF₂CH₂—OCOO—CH₂CH₃ (ethyl 2,2-difluoroethyl carbonate, CAS No. 916678-14-3), and CF₃CH₂—OCOO—CH₂CH₃ (ethyl 2,2,2-trifluoroethyl carbonate, CAS No. 156783-96-9).

Other suitable fluorinated acyclic ethers are represented by the formula: R⁵—O—R⁶, where R⁵ and R⁶ independently represent an alkyl group, the sum of carbon atoms in R⁵ and R⁶ is 2 to 7, at least two hydrogen atoms in R⁵ and/or R⁶ are replaced by fluorine atoms and neither R⁵ nor R⁶ contains a FCH₂or FCH group. Examples of suitable fluorinated acyclic ethers include without limitation HCF₂CF₂CH₂—O—CF₂CF₂H (CAS No. 16627-68-2) and HCF₂CH₂—O—CF₂CF₂H (CAS No. 50807-77-7).

A mixture of two or more of these fluorinated acyclic carboxylic acid ester, fluorinated acyclic carbonate, and/or fluorinated acyclic ether solvents may also be used. Other suitable mixtures can include anhydrides. One suitable electrolyte solvent mixture includes a fluorinated acyclic carboxylic acid ester, ethylene carbonate, and maleic anhydride, such as 2,2-difluoroethyl acetate, ethylene carbonate, and maleic anhydride. The electrolyte composition can comprise about 61% 2,2-difluoroethyl acetate, about 26% ethylene carbonate, and about 1% maleic anhydride by weight of the total electrolyte composition.

The electrolyte compositions described herein can also contain at least one electrolyte salt. Suitable electrolyte salts include without limitation

lithium hexafluorophosphate (LiPF₆),

lithium tris(pentafluoroethyl)trifluorophosphate (LiPF₃(C₂F₅)₃),

lithium bis(trifluoromethanesulfonyl)imide,

lithium bis(perfluoroethanesulfonyl)imide,

lithium (fluorosulfonyl) (nonafluorobutanesulfonyl)imide,

lithium bis(fluorosulfonyl)imide,

lithium tetrafluoroborate,

lithium perchlorate,

lithium hexafluoroarsenate,

lithium trifluoromethanesulfonate,

lithium tris(trifluoromethanesulfonyl)methide,

lithium bis(oxalato)borate,

lithium difluoro(oxalato)borate,

Li₂B₁₂F₁₂₋ₓHₓ where x is equal to 0 to 8, and

mixtures of lithium fluoride and anion receptors such as B(OC₆F₅)₃.

Mixtures of two or more of these or comparable electrolyte salts may also be used. A suitable electrolyte salt is lithium hexafluorophosphate. The electrolyte salt can be present in the electrolyte composition in an amount of about 0.2 to about 2.0 M, or about 0.3 to about 1.5 M, or about 0.5 to about 1.2 M.

The optimum range of salt and solvent concentrations in the electrolyte may vary according to specific materials being employed and the anticipated conditions of use, for example, according to the intended operating temperature. In one embodiment, the solvent is 20 to 40 parts by volume of ethylene carbonate and 60 to 80 parts by volume of ethyl methyl carbonate, and the salt is LiPF₆.

Alternatively, the electrolyte may comprise a lithium salt such as, lithium hexafluoroarsenate, lithium bis-trifluoromethyl sulfonamide, lithium bis(oxalate)boronate, lithium difluorooxalatoboronate, or the Li⁺ salt of polyfluorinated cluster anions, or combinations of these. Alternatively, the electrolyte may comprise a solvent, such as, propylene carbonate, esters, ethers, or trimethylsilane derivatives of ethylene glycol or poly(ethylene glycols) or combinations of these. Additionally, the electrolyte may contain various additives known to enhance the performance or stability of Li-ion batteries, as reviewed for example by K. Xu in Chem. Rev., 104, 4303 (2004), and S. S. Zhang in J. Power Sources, 162, 1379 (2006).

The housing of the electrochemical cell may be any suitable container to house the electrochemical cell components described above. Such a container may be fabricated in the shape of a cylindrical battery, a rectangular battery, a coin-type battery, or a pouch-type battery; and according to a size, a bulky battery and a thin-film type battery. Methods of manufacturing the lithium secondary batteries as described above are widely known in the art.

The electrochemical cell or lithium-ion battery disclosed herein may be used for grid storage or as a power source in various electronically-powered or -assisted devices (“electronic device”) such as a transportation device (including a motor vehicle, automobile, truck, bus or airplane), a computer, a telecommunications device, a camera, a radio or a power tool.

It is understood that the embodiments described herein disclose only illustrative but not exhaustive examples of the invention set forth.

### EXAMPLES

Chemicals were reagent grade or better and used as received unless otherwise stated. Ion-chromatography grade water (18 MΩ) obtained from a Satorius Arium 611 DI unit (Sartorius North America Inc., Edgewood, N.Y.) was used to prepare solutions and rinse glassware prior to use. Titanium tetrachloride was obtained from Sigma-Aldrich (208566-200G in SureSeal™ bottle) and used without purification. TiOCl₂ solution was prepared by the addition of TiCl₄ to water at 0° C. Anatase was obtained from Alfa Aesar and used as received. Lithium carbonate and lithium nitrate were obtained from Sigma-Aldrich or Alfa Aesar and were ground prior to use to reduce particle size by ball milling of dry solids. Copper formate monohydrate (Sigma-Aldrich), copper formate tetrahydrate (Pfaltz and Bauer), and copper hydroxide (Sigma-Aldrich) were used as sources of copper ion.

The meaning of abbreviations used in the following examples is as follows: “g” means gram(s), “mg” means milligram(s), “μg” means microgram(s), “L” means liter(s), “mL” means milliliter(s), “mol” means mole(s), “mmol” means millimole(s), “M” means molar concentration, “wt %” means percent by weight, “h” means hour(s), “min” means minute(s), “m” means meter(s), “cm” means centimeter(s), “mm” means millimeter(s), “μm” means micrometer(s), “nm” means nanometer(s), “mils” means thousandths of an inch, “lbs” means pounds, “kN” means kilonewtons, “rpm” means revolutions per minute, “A” means ampere(s), “mA” means milliampere(s), “mAh/g” means milliampere hour(s) per gram, “V” means volt(s), “xC” refers to a constant current which is the product of x and a current in A which is numerically equal to the nominal capacity of the battery expressed in Ah, “XRD” means X-ray diffraction, “TGA” means thermal gravimetric analysis, “SEM” means scanning electron microscopy, ICP-AES means Inductively Coupled Plasma-Atomic Emission Spectrometry, “MΩ” means megaohm(s).

Surface area was measured by standard Brunauer-Emmett-Teller (BET) techniques.

Except where otherwise indicated, XRD data was collected using a Philips X′PERT automated powder diffractometer, Model 3040. The diffractometer is equipped with automatic variable anti-scatter and divergence slits, X′Celerator RTMS detector and Ni filter. The radiation is CuK(alpha) (45 kV, 40 mA). Data were collected at room temperature from 4 to 80 degrees 2-theta using a continuous scan with an equivalent step size of 0.02 degrees and a count time of 80 sec. per step. Samples were finely ground powders mounted as smears on a low-background, silicon specimen holder.

The purity of the LTO phase is derived from the XRD data wherein the weight fraction of LTO is calculated from the intensity of the diffraction peaks relative to other crystalline phases present.

Coin cells were fabricated using standard techniques (T. Marks, S. Trussler, A. J. Smith, D. Xiong, and J. R. Dahn, Journal of the Electrochemical Society, 2011, 158, A51-A57) with a 80:10:10 mixture of lithium titanate: carbon: PVDF (polyvinylidene difluorde). 1-Methyl-2-pyrrolidone was used as solvent to form a paste for deposition of the active material on a copper foil. Li metal was used as the counter electrode. The coin cells were assembled in a dry box (Vacuum Atmospheres Co., Topsfield, Mass.) under an argon atmosphere. The electrochemical performance of various lithium titanates was evaluated in coin cells with half-cell configuration. Electrochemical data was obtained on a Maccor potentiostat (Maccor, Inc., Tulsa, Okla.).

The C rate means how many times a charge or discharge cycle is run in 1 hour at a specified current. At 10 C rate, the charge or discharge cycle is completed in an hour. At a 10 C rate, the cycles are completed in 6 minutes.

### Example 1

### Preparation of Hydrated Titanium Oxide (HTO)

To prepare hydrated titanium dioxide water (245.6 mL) was placed in a 3-neck Morton flask attached to a temperature controller, overhead stirrer, and peristaltic pump. The water was heated to 80° C. When the water in the flask reached 80° C., a TiOCl₂ solution (250 mL 1.97 M prepared by the hydrolysis of TiCl₄ in cold water) was added to the flask with a pump over a period of about 2 hr with the stirrer rotating at an impeller speed of 825 RPM. Heat, with stirring, was continued for an additional 45 minutes. Heat was then removed and, after the reaction cooled to room temperature, solids were collected via vacuum filtration, washed with water, and left under vacuum overnight. Additional drying was done in a vacuum oven at 75° C. for about 4 hours. The resulting HTO solid was easily crushed into a white powder with an agate mortar and pestle.

### Example 2

### Preparation of Cu-LTO with 1 wt % Copper

HTO from Example 1 and lithium carbonate (0.8/1 Li/Ti ratio) were mixed together in Li₂CO₃-saturated water and milled in a jar-mill with yttrium stabilized zirconia media (diameter=5 mm) for 3 days followed by filtration and drying. The milled HTO/Li₂CO₃ solid (5.036 g) was combined with the copper formate monohydrate (0.671 g) and 10 mL of water which dissolved the copper formate and allowed intimate mixing the ingredients. The mixture was dried, ground with an agate mortar and pestle and calcined at 800° C. for 2 hours to yield a tan Cu-LTO powder (Ex. 2a). The same procedure was used to prepare a comparative LTO from the HTO-Li₂CO₃ mixture without copper formate (Comp. Ex. 2b). Analytical data are shown in Table 2-1.

TABLE 2-1

| Property | Ex. 2a | Comp. Ex. 2b |
|---|---|---|
| LTO (wt %) | 96.4 | 95.9 |
| Li₂TiO₃ (wt %) | <1 | 0 |
| TiO₂ (wt %) | 3.4 | 4.1 |
| Surface area (m²/g) | 5.7 | 6.1 |
| Cu (wt %) | 1.08 | 0 |

Coin cells were prepared and tested for each material. The results, summarized in Table 2-2, demonstrate the improved capacity of the Ex 2a Cu-LTO material compared with the unmodified Comp. Ex. 2b material. Capacities at the 5 C rate are the same for the two samples, but those at 10, 15, and 20 C are higher for the Cu-LTO sample. These results indicate the 1.08 wt % copper content in LTO increases the capacity at high C rates (10, 15, and 20 C) compared with the pure LTO phase.

TABLE 2-2

Capacity (mAh/g)

| C Rate | Ex. 2a | Comp Ex. 2b |
|---|---|---|
| 0.1 | 162 | 168 |
| 1 | 157 | 163 |
| 5 | 149 | 146 |
| 10 | 139 | 123 |
| 15 | 124 | 93 |
| 20 | 87 | 55 |

### Example 3

### Preparation of Cu-LTO with Various Cu Levels

A series of copper-modified LTO samples were prepared with copper ranging from zero to 6.67 wt %. Lithium nitrate, copper formate and 10 mL of water were mixed together in an agate mortar and pestle. HTO was then added. Table 3-1 lists the amount of each reagent for the preparation of samples. In all cases, the lithium to titanium molar ratio was 0.80. The slurry was allowed to soak for 4 hours after which the mixture was moved to a vacuum oven overnight to dry at 75° C. The dried solids were then ground with an agate mortar and pestle and calcined at 800° C. for 8 hours. The resulting powder was recovered from the furnace and lightly ground with an agate mortar and pestle to remove any large clumps. Analytical results are given in Table 3-2; coin cell capacity results are given in Table 3-3.

TABLE 3-1

| | | | Cu(OOCH) |
|---|---|---|---|
| Sample | HTO (g) | LiNO₃ (g) | hydrate (g) |
| Comp. 3a | 4.1841 | 2.6452 | 0 |
| Ex. 3b | 4.3072 | 2.7214 | 0.0344 |
| Ex. 3c | 4.1247 | 2.6051 | 0.1179 |
| Ex. 3d | 4.3219 | 2.7339 | 0.1536 |
| Ex. 3e | 4.3421 | 2.7452 | 0.382 |
| Ex. 3f | 4.4668 | 2.8205 | 0.7908 * |
| Ex. 3g | 4.6579 | 2.9427 | 1.1069 * |

* Prepared with copper formate tetrahydrate.

TABLE 3-2

| | Cu | LTO | Surface Area |
|---|---|---|---|
| Sample | (wt %) | (wt %) | (m²/g) |
| Comp. 3a | 0 | 96.2 | 3.6 |
| Ex. 3b | 0.31 | 94.0 | 3.9 |
| Ex. 3c | 1.08 | 97.0 | 3.8 |
| Ex. 3d | 1.29 | 96.3 | 3.7 |
| Ex. 3e | 2.98 | 97.1 | 3.7 |
| Ex. 3f | 5.20 | 97.9 | 3.1 |
| Ex. 3g | 6.67 | 97.8 | 3.2 |

TABLE 3-3

| | Capacity (mAh/g) | | | | | |
|---|---|---|---|---|---|---|
| Sample (wt % Cu) | 0.1 C | 1 C | 5 C | 10 C | 15 C | 20 C |
| Comp. 3a | 163 | 156 | 116 | 89 | 73 | 60 |
| Ex. 3b (0.31) | 173 | 163 | 121 | 92 | 73 | 51 |
| Ex. 3c (1.08) | 166 | 158 | 127 | 98 | 79 | 60 |
| Ex. 3d (1.29) | 164 | 157 | 129 | 103 | 85 | 71 |
| Ex. 3e (2.98) | 156 | 146 | 135 | 117 | 100 | 75 |
| Ex. 3f (5.20) | 149 | 140 | 129 | 116 | 103 | 83 |
| Ex. 3g (6.67) | 143 | 131 | 119 | 105 | 76 | 43 |

Cu-LTO at loadings above 1 wt % copper improved the capacity at 5, 10, and 15 C rates compared to the comparative sample. Cu-LTO samples with 1.3, 3, and 5.2 wt % percent copper show an increased capacity at 20 C as well. Because the purity and surface areas of these samples are very similar, capacity differences cannot be attributed to differences in these properties. The Cu-LTO sample with 5.2 wt % copper has the lowest BET surface area, but the capacities at 5, 10, 15, and 20 C rates are equal or exceed those of the other samples with higher surface area including the unmodified LTO comparative sample 3a. Capacities at 10 C show a significant increase from no copper to 5% copper.

### Example 4

### Preparation of Cu-LTO with Varying Calcination Time

Lithium nitrate (2.6613 g) and copper(II) formate tetrahydrate (0.4996 g) were mixed in 10 mL of water in an agate mortar. Hydrated titanium oxide (4.2156 g of hydrated titanium oxide, 91.8% TiO₂ by TGA) was added to the solution and allowed to soak for approximately 4 hours. These amounts yield a lithium to titanium molar ratio of 0.80. The mortar was then moved to a vacuum oven at 75° C. overnight to remove the water. The dried solids were ground into a powder with an agate mortar and pestle and calcined at 800° C. for 4 hours. A tan powder, 4.5744 g (Ex. 4a), was recovered from the furnace and lightly ground to remove any large clumps.

The process was repeated with hydrated titanium oxide (4.4791 g), LiNO₃ (2.8295 g) and copper formate tetrahydrate (0.5311 g). Calcination at 800° C. for two hours yielded 4.7631 g of tan powder (Ex. 4b).

The process was repeated a third time with hydrated titanium oxide (4.399 g), LiNO₃ (2.7776 g) and copper formate tetrahydrate (0.5255 g) and a calcination time at 800° C. of one hour. A tan powder, 4.824 g (Ex. 4c) was recovered.

Analytical results are summarized in Table 4-1. Electrochemical data from coin cell tests is summarized in Table 4-2.

TABLE 4-1

| | Copper | LTO | Surface Area |
|---|---|---|---|
| Sample | (wt %) | (wt %) | (m²/g) |
| Ex. 4a | 3.41 | 97 | 3.6 |
| Ex. 4b | 3.59 | 95 | 3.8 |
| Ex. 4c | 3.59 | 95 | 3.8 |

TABLE 4-2

| | Capacity (mAh/g) | | |
|---|---|---|---|
| C Rate | Ex. 4a | Ex. 4b | Ex. 4c |
| 0.1 | 156 | 156 | 154 |
| 1 | 149 | 147 | 145 |
| 5 | 138 | 135 | 135 |
| 10 | 122 | 118 | 123 |
| 15 | 96 | 88 | 104 |
| 20 | 53 | 45 | 65 |

The capacities listed in Table 4-1 show that Cu loading in the range of 3.4 to 3.6 weight percent improves the capacity at 5, 10, and 15 C rates. The purity and surface areas of these samples are very similar. Calcination times of 1, 2, and 4 hours generate Cu-LTO phases showing the same rates at the higher C rates as samples generated with longer calcination time (Example 3). All of these Cu-LTO samples show higher capacities at 5, 10, 15 and 20 C rates compared with the LTO sample without copper modification (Comp. 3a)

### Example 5

### Cu-LTO Preparation from Anatase

A series of copper-modified LTO samples were prepared from anatase as the titanium source. Anatase TiO₂ and lithium carbonate (0.80 Li/Ti molar ratio) were added to a plastic jar loaded with about 60 g of 10 by 10 mm cylindrical YTZ grinding media. Also added to the jar was enough Li₂CO₃-saturated water to form a 33 wt % slurry. The mixture was rolled on a jar mill for 90 hours followed by vacuum filtration and drying in a vacuum oven. The dried solids were ground with an agate mortar and pestle into a fine powder and then calcined at 800° C. for 2 hours.

Ingredient amounts for each sample (Comp. 5a, Ex. 5b-5d) are shown in Table 5.1. Analytical results are summarized in Table 5-2. The copper-modified LTO samples were tan in color whereas the comparative LTO sample without copper was white. Electrochemical data from coin cell tests is summarized in Table 5-3.

TABLE 5-1

| Sample | TiO₂ (g) | Li₂CO₃ (g) | Cu(OH)₂ (g) | Sample wt (g) |
|---|---|---|---|---|
| Comp. 5a | 4.6160 | 1.7008 | 0 | 5.242 |
| Ex. 5b | 4.7156 | 1.7382 | 0.1389 | 5.3687 |
| Ex. 5c | 4.9409 | 1.8213 | 0.3063 | 5.7092 |
| Ex. 5d | 4.8404 | 1.7874 | 0.4423 | 5.6661 |

TABLE 5-2

| | LTO | TiO₂ | Cu | Surf. Area |
|---|---|---|---|---|
| Sample | (wt %) | (wt %) | (wt %) | (m²/g) |
| Comp. 5a | 99 | <1 | 0 | 5.1 |
| Ex. 5b | 99 | 1 | 1.49 | 5.4 |
| Ex. 5c | 99 | <1 | 3.07 | 5.1 |
| Ex. 5d | 99 | <1 | 4.47 | 4.8 |

TABLE 5-3

Capacity (mAh/g)

| C Rate | Comp. 5a | Ex. 5b | Ex. 5c | Ex. 5d |
|---|---|---|---|---|
| 0.1 | 170 | 165 | 158 | 151 |
| 1 | 164 | 159 | 150 | 140 |
| 5 | 123 | 134 | 135 | 131 |
| 10 | 88 | 100 | 113 | 118 |
| 15 | 48 | 58 | 81 | 103 |
| 20 | 27 | 28 | 37 | 72 |

All of the Cu-LTO samples show higher capacities than the LTO sample at 5, 10, and 15 C rates. The Cu-LTO samples with the higher copper content also showed higher capacities at 20 C. The Cu-LTO sample 5d (4.47 wt % Cu) showed the highest capacities at these C rates.

### Example 6

### X-Ray Data and Space Group Determination

A fresh sample of Cu-LTO was prepared for x-ray analysis. Lithium nitrate (2.6351 g), and copper(II) formate tetrahydrate (0.4962 g) were mixed with 10 mL of water in an agate mortar. Hydrated titanium oxide (4.1757 g, 91.8 wt % TiO₂ by TGA) was added to the solution and allowed to soak for approximately 4 hours. These amounts of reagents yield a lithium to titanium molar ratio of 0.80. The mortar was then moved to a 75° C. vacuum oven at to dry. The dried solids were ground into a powder and calcined at 800° C. for 8 hours in a boat with the following dimensions: 7.75×5×0.75 cm. A tan powder, 4.5043 g (Ex. 6a), was recovered from the furnace and lightly ground to remove any large clumps. Analytical data is summarized in Table 6-1. The weight percent Ti, Li and Cu was determined by ICP-AES

TABLE 6-1

| Property | Ex. 6a |
|---|---|
| LTO (wt %) | 95.6 |
| Li₂TiO₃ (wt %) | 2.7 |
| TiO₂ (wt %) | 1.7 |
| Cu (wt %) | 3.28 |
| Ti (wt %) | 51.90 |
| Li (wt %) | 5.80 |
| Surface Area (m²/g) | 3.6 |

The unmodified LTO control used for this example was Comp. 3a above.

Sample 6a and the control sample were analyzed at the Advanced Photon Source, Argonne National Laboratory. Powder diffraction data were obtained at DuPont-Northwestern-Dow Collaborative Access Team (DND-CAT) sector 5. Beamline 5IDB (insertion device line) was used for detection of trace crystalline phases and Beamline 5BMC was used for acquisition of low-noise data with accurate relative peak intensities and peak positions for whole profile refinement. Diffractometers on both were operated with Si(111) double-crystal monochromators at wavelengths of 0.7105 Å (5IDB) and 0.7282 Å (5BMC), and were equipped with Si(111) analyzers and scintillation detectors. Finely ground powder samples were packed into a 1 mm glass capillary, which was spun at 1 revolution per second during data acquisition over the range 7°<2-theta<55°. Data analysis, including whole profile refinement, was done with Jade 9.5 Software from Materials Data, Inc.

The extraordinary brilliance of the 5IDB insertion device line allows detection of crystalline phases at the 100 ppm level, however the extreme heat load placed on its optics leads to wavelength stability issues that render the data unsuitable for whole profile refinement. For this reason the data for whole profile refinement in this example were obtained on the lower brilliance bending magnet source of 5BMC.

Whole profile refinement of the control Li₄Ti₅O₁₂ using the cubic spinel Fd-3m structure resulted in an excellent fit to diffraction data. Residuals are small and reflect an imperfect fit to the observed peak shapes rather than disagreement between the observed and calculated peak intensities. When the data for the Cu modified Ex. 6a was modeled against the control LTO, there was systematic variation in peak intensities relative to the control suggesting the presence of copper in the LTO lattice.

The discrepancies in calculated vs. observed peak intensities, shifts in lattice constants and the presence of residual rutile were first observed with conventional, x-ray tube source, laboratory diffractometers. However the more accurate absolute peak intensities obtained at 5BMC were used to confirm the conventional X-ray results and ensure the absence of instrumental artifacts.

X-ray absorption near edge spectroscopy conducted on Ex. 6a using beamline 5BMD (DND-CAT) indicates that all Cu is present as Cu²⁺ and all Ti is present at Ti⁴⁺. Any Cu—Ti substitution must take this into account when calculating charge balance. Given that in the unmodified control sample there is insufficient Li to convert all the rutile, and recognizing the reduction in rutile with Cu addition, it is concluded some Cu substitutes for Li. However, if all the Cu substitutes for Li there would be no rutile at 5% Cu. Therefore, it was concluded that some Cu also substitutes for Ti. Cu²⁺ and Li⁺ are very similar in size but Cu²⁺ is much larger than Ti⁴⁺. The observed lattice expansion with increasing copper content is consistent with at least some substitution of Cu²⁺ for Ti⁴⁺.

A model which fits all the observations is one in which for every three Cu²⁺ atoms, two substitute for Li+ on either the 8a or 16c sites and one substitutes for Ti⁴⁺ on the 16c site. This model produces an improved fit in whole profile refinement, matches the observed reduction in rutile and, with a 3% reduction in expected Cu²⁺ to O²⁻ distance, matches the lattice constant data as well. A minor reduction in Cu-0 distance is reasonable considering that neighboring Ti⁴⁺ in corner sharing octahedral should draw oxygen charge away from the less positive copper and shorten the Cu-0 distance. This model gives rise the Cu-LTO formula (I).

The insertion device was used to examine sample 6a for the presence of even minute amounts of other crystal phases. Only two crystalline phases were observed, the cubic spinel and the rutile form of TiO₂. No copper oxides or double spinel phase were detected. With regard to the double spinel phase, Li₂CuTi₃O₈ (space group P4₃32), the data was closely examined for the presence of the characteristic 210 peak which occurs at 2 theta of about 24 (Cu K-alpha radiation) and which would occur at a 2-theta of about 11 with radiation wavelength of the insertion device. Within the detection limits of the insertion device, which are about 100 ppm, no peak corresponding to 210 peak was observed indicating the absence of the double spinel phase.

What is claimed is:

1. A modified lithium titanate compound represented by formula I:
Li₄₋₂ₓTi₅₋ₓCu₃ₓO₁₂ (I)
wherein x is a fraction in the range of 0.025 to 0.370, and
said compound (I) is a single phase cubic spinel with space group Fm-3m.

2. The modified lithium titanate compound of claim 1 wherein said compound is in the form of a powder having a volume median particle size in the range of 0.1 μm to 100 μm.

3. The modified lithium titanate compound of claim 1 wherein x is in the range of 0.05 to 0.25.

4. The modified lithium titanate compound of claim 1 wherein x is in the range of 0.099 to 0.185.

5. An electrode comprising the modified lithium titanate of claim 1 as an electroactive material.

6. The electrode of claim 6 further comprising any one or combination of components selected from the group consisting of binder and conductivity agent.

7. A lithium-ion battery comprising an anode, a cathode, a separator and electrolyte wherein said anode is the electrode of claim 5 or 6.

8. A lithium-ion battery comprising an anode, a cathode, a separator and electrolyte wherein said anode comprises modified lithium titanate of claim 1.

9. An electronic device comprising a battery according to claim 8
